(19) United States
(12) Patent Application Publication
(10) Pub. No.: US 2016/0167394 A1
(43) Pub. Date: Jun. 16, 2016

(54) Method for Printing Security Documents on Thermal Paper

(71) Applicant: CTPG Operating, LLC, Ithaca, NY (US)

(72) Inventor: Jeffrey C. Phoenix, Brooktondale, NY (US)

(73) Assignee: CTPG Operating, LLC, Ithaca, NY (US)

(21) Appl. No.: 14/968,793

(22) Filed: Dec. 14, 2015

Related U.S. Application Data
(60) Provisional application No. 62/091,241, filed on Dec. 12, 2014.

(51) Int. Cl. B41J 2/325

(52) U.S. Cl. CPC B41J 2/325

(57) ABSTRACT

A thermal printer configured to emboss a security feature onto print media, the thermal printer being programmed with an algorithm, the algorithm includes the steps of: receiving print media having a plurality of microspheres, wherein each of the plurality of microspheres is configured to independently expand when heated; receiving a desired design to be embossed on the print media; selectively heating a portion of the print media in the shape of the desired design, such that the heated microspheres expand and emboss the print media with the desired design.

### CROSS-REFERENCE TO RELATED APPLICATIONS

This application claims priority to U. S. Provisional Patent Application Ser. No. 62/091,241, filed on Dec. 14, 2014 and entitled “System and Method for Printing Security Documents on Thermal Paper” the entire disclosure of which is incorporated herein by reference.

### FIELD OF INVENTION

The present invention relates to a method to emboss thermal paper for printing secure documents.

### BACKGROUND

Thermal media is widely used to print vouchers. Security features printed on thermal paper, if employed can be “washed” off and new information printed with ink jet or laser printers. In most copy fraud, a scanner can be used to copy the digital image and reproductions can be made with a standard laser printer. Accordingly, there is a need in the art for a security pattern which cannot be “washed” off or easily scanned and reproduced by a thief.

### SUMMARY

The present disclosure is directed to inventive methods and systems for embossing print media with a security pattern. Various embodiments and implementations herein are directed to a thermal printer that is programmed to selectively heat print media having a plurality of microspheres. The print media is embossed as the microspheres expand from the applied heat. Accordingly, by selectively heating the microspheres, any pattern or text may be embossed on the print media.

The advantage of a thermal paper with raised patterns over standard thermal paper is that the added pattern thickness can be very difficult for a counterfeiter or thief to reproduce. On a document with the microspheres on the paper, the scanner will not be able to reproduce the raised pattern security feature. The counterfeiter will need to try to copy the raised pattern with some secondary operation on the paper. This additional operation will most likely discourage most counterfeiters.

When the secure document is presented for authentication, the raised pattern on the paper can be felt by the validator checking the document. If it is missing, the illegal copy is easily detected.

Using a thermal printhead to create the raised patterns provides additional levels of security as the raised pattern can be changed on demand. The producer of the secure document can send a different pattern to each document if desired. By changing the raised pattern often, the producer of the secure document makes it more difficult for the counterfeiter to be successful at reproducing the original.

According to an aspect, a thermal printer is configured to emboss a security feature onto print media, the thermal printer being programmed with an algorithm, the algorithm comprising the steps of: receiving print media having a plurality of microspheres, wherein each of the plurality of microspheres is configured to independently expand when heated receiving a desired design to be embossed on the print media; selectively heating a portion of the print media in the shape of the desired design, such that the heated microspheres expand and emboss the print media with the desired design.

In an embodiment, the step of selectively heating a portion of the print media comprises the steps of: selectively heating a first portion of the print media to a first temperature; selectively heating a second portion of the print media to a second temperature, wherein the first temperature is higher than the second temperature, such that the resulting embossing of the first portion is higher than the embossing of the second portion.

In an embodiment, the print media only includes the microspheres on a predetermined portion of the print media.

In an embodiment, the thermal printer is programmed to only heat the portion of the print media including the microspheres.

In an embodiment, the desired design is text or a pattern.

In another aspect, a method of embossing a security feature onto print media, comprises: receiving print media having a plurality of microspheres, wherein each of the plurality of microspheres is configured to independently expand when heated; receiving a desired design to be embossed on the print media; selectively heating a portion of the print media in the shape of the desired design, such that the heated microspheres expand and emboss the print media with the desired design.

In an embodiment, the step of selectively heating a portion of the print media comprises the steps of: selectively heating a first portion of the print media to a first temperature; selectively heating a second portion of the print media to a second temperature, wherein the first temperature is higher than the second temperature, such that the resulting embossing of the first portion is higher than the embossing of the second portion.

In an embodiment, the print media only includes the microspheres on a predetermined portion of the print media

In an embodiment, the step of selectively heating a portion of the print media only heats the portion of the print media including the microspheres.

In an embodiment, the desired design is text or a pattern.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a schematic of print media having a plurality of microspheres.

FIG. 2 is a schematic of print media having a plurality of microspheres.

FIG. 3A is flowchart for embossing print media with a thermal printer.

FIG. 3B is a flowchart for embossing print media with a thermal printer.

### DETAILED DESCRIPTION

An embodiment of the present invention is directed to a thermal printer used to print secure documents. In an embodiment, the printer comprises a printhead containing a plurality of resistive elements (i.e. a resistor). A voltage may be applied to one or more of the resistive elements to heat the element. Using the one or more heated elements, the printer may selectively heat a piece of paper loaded into the printer in a predetermined design. In this way, the printer may print onto the paper, via the selective application of heat, a design, such as text or a pattern, of the user's choice.

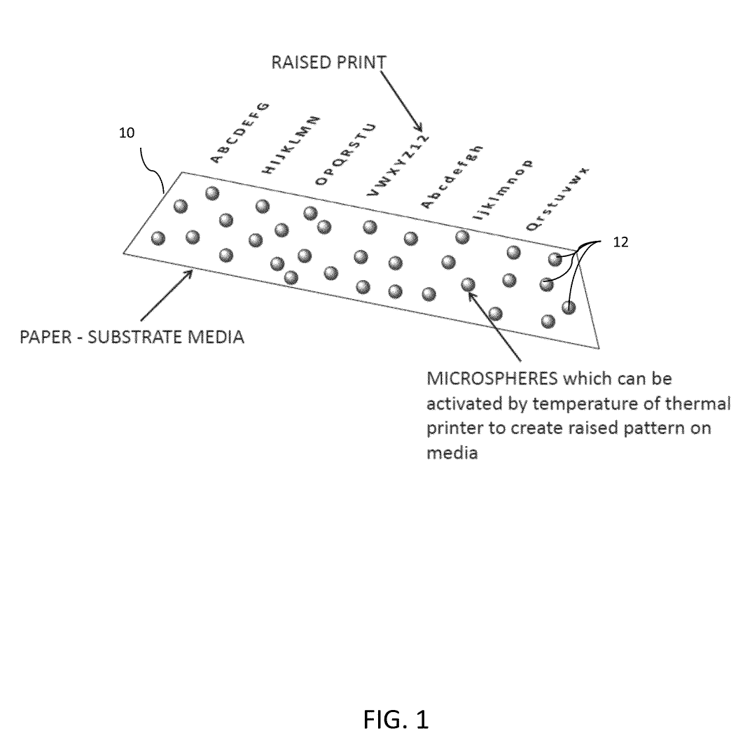

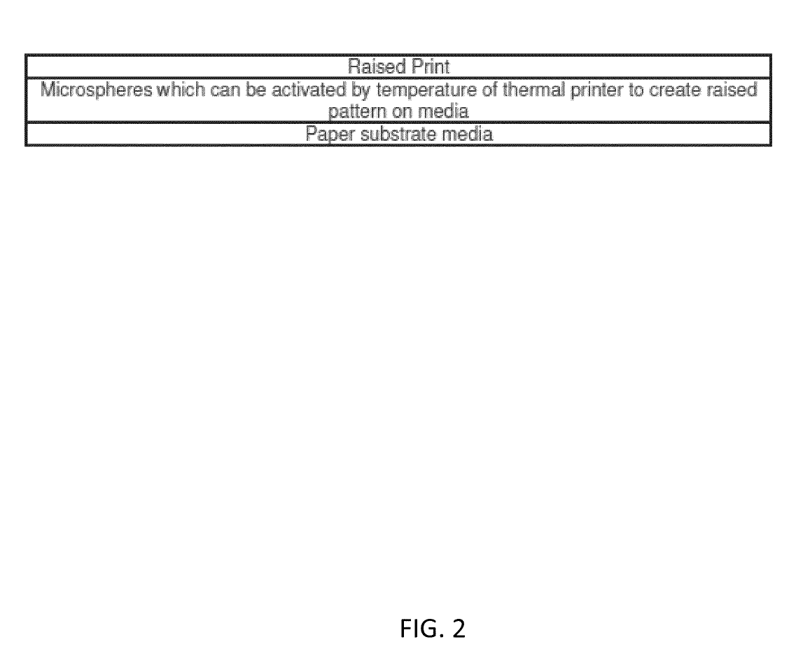

Referring now to the drawings, wherein like reference numerals refer to like parts throughout, there is shown in FIGS. 1 and 2, a schematic of print media 10 according to an embodiment. In the embodiment, the surface of the paper media loaded into the thermal printer may contain microspheres 12 that are activated by temperature. The microspheres 12 may be applied to the paper media as a surface coating. In an alternate embodiment the microspheres 12 may embedded into the fibers of the paper media itself. The microspheres 12 may comprise spherically formed particles with a thermoplastic (such as a copolymer of Acrylonitrile) shell encapsulating a gas. When the microspheres 12 are heated by the thermal printhead, the thermoplastic shell softens and the gas increases its pressure, resulting in an expansion of the spheres. The expansion of the spheres will cause the paper media coating or the paper itself to rise. Thus, by selectively heating the microspheres 12, a design (such as a pattern or text) may be embossed onto the print media 10. For example, to emboss a square onto the surface of the print media 10, the printhead may be configured to heat the surface of print media 10 in a square shape. As the surface is heated in the shape of the square, the microspheres 12 in the heated portion will begin to rise, and the square will be embossed onto the surface of the print media 10. Accordingly, the printer may be programmed to properly heat the microspheres 12 to emboss the print media 10.

Furthermore, the height of the embossing may be varied by applying varying degrees of heat to the surface of the print media 10. For example, a small amount of heat may be applied to a certain portion of the print media 10, to cause the microspheres 12 to rise to some fraction of their potential height. A larger amount of heat may be applied to a different portion of the print media 10 to cause the microspheres 12 in that portion to rise to a larger fraction of their potential height, or to the maximum of their potential height. The amount of heat may be varied by adjusting the voltage applied to each resistive element and/or the amount of time the print media 10 is exposed to the resistive element.

In an embodiment, the density of microspheres 12 on the print media 10 may be such that the printer may be agnostic to the location of the microspheres 12 on the print media 10, and may simply heat any desired portion of the print media 10 with the correct heat to achieve the desired embossing. Alternately, the print media 10 may contain the microspheres 12 at select portions or locations on the print media 10, so that the printer may be programmed to heat only the select portions of the print media 10 to achieve the embossing.

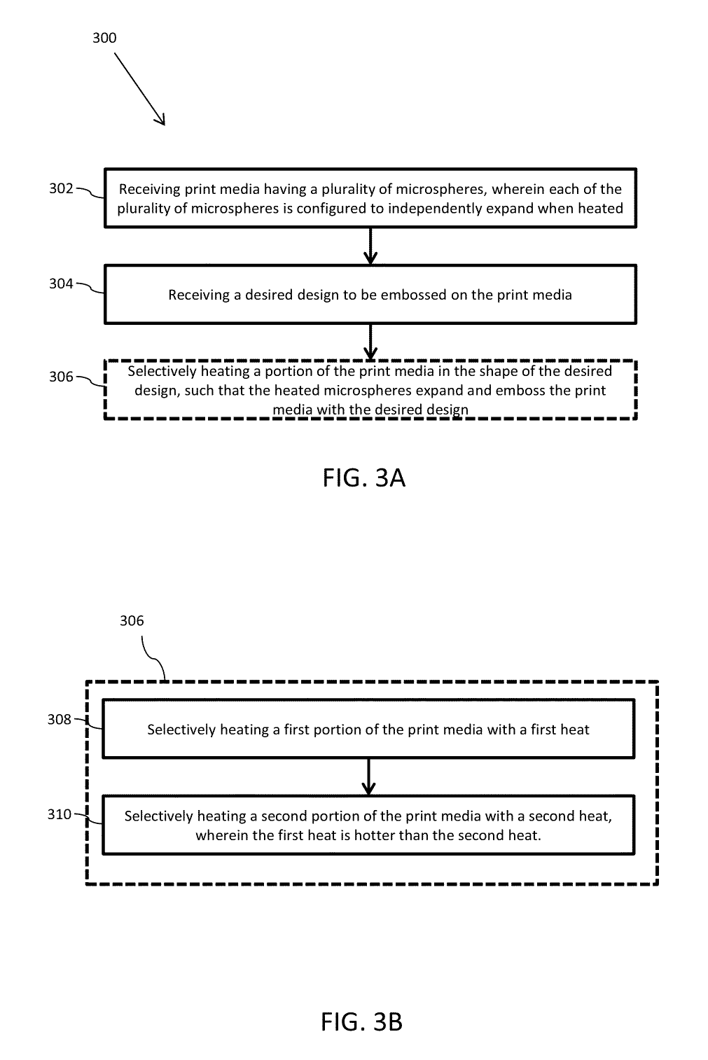

FIG. 3A depicts an algorithm 300 for embossing, using a thermal printer, a desired design onto print media 10 having a plurality of microspheres 12 as described in FIGS. 1 and 2 and the above description.

In step 302, the thermal printer receives print media 10 having a plurality of microspheres 12. Each of the plurality of microspheres 12 is configured to independently expand when heated. The expanded microspheres 12 will cause the surface of the print media 10 to rise, thus embossing the surface.

In step 304, a desired design is received by the thermal printer. The desired design may be sent from a host computer, mobile device, or any other device capable of sending a design to the thermal printer. It should be appreciated that the desired design may be sent to the thermal printer at any time. Indeed, the thermal printer may have the design stored upon manufacture, or it may be pre-programmed by a user prior to loading the print media 10. Of course, the desired design may be received after the print media 10 has been received. The desired design may also be selected from a plurality of pre-stored designs. The desired design may be a security design.

In step 306, the print media 10 is selectively heated in the shape of the desired design, such that the heated microspheres 12 expand and emboss the print media 10 with the desired design. For example, as outlined above, the thermal printer may heat the print media 10 in the shape of a square, causing the heated microspheres 12 to expand in the shape of a square on the print media 10.

FIG. 3B depicts an embodiment of step 306. In substep 308, a first portion of the print media 10 is heated to a first temperature. In substep 310, a second portion of the print media 10 is heated to a second temperature, with the first temperature being higher than the second temperature, causing the microspheres 12 of the first portion to expand more than the second portion. Thus, certain portions of the desired design may exhibit a higher embossing than other portions by applying greater temperatures or heating for a shorter period of time. For example, if a square is to be embossed on the print media 10, the left side of the square may be heated to one temperature and the right side of the square may be heated to a second temperature. If the first temperature is higher than the second temperature, the embossing of the left side may be higher than the right side.

Of course, if only a portion of the print media 10 contains the microspheres 12, the thermal printer may be programmed to only heat that portion of the print media 10.

A “module,” as may be used herein, can include, among other things, the identification of specific functionality represented by specific computer software code of a software program. A software program may contain code representing one or more modules, and the cod representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, completely or partly on the thermal printer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While several embodiments of the invention have been discussed, it will be appreciated by those skilled in the art that various modifications and variations of the present invention are possible. Such modifications do not depart from the spirit and scope of the present invention.

What is claimed is:

1. A thermal printer configured to emboss a security feature onto print media, the thermal printer being programmed with an algorithm, the algorithm comprising the steps of:
receiving print media having a plurality of microspheres, wherein each of the plurality of microspheres is configured to independently expand when heated;
receiving a desired design to be embossed on the print media;
selectively heating a portion of the print media in the shape of the desired design, such that the heated microspheres expand and emboss the print media with the desired design.

2. The thermal printer of claim 2, wherein the step of selectively heating a portion of the print media comprises the steps of:
selectively heating a first portion of the print media to a first temperature selectively heating a second portion of the print media to a second temperature, wherein the first temperature is higher than the second temperature, such that the resulting embossing of the first portion is higher than the embossing of the second portion.

3. The thermal printer of claim 1, wherein the print media only includes the microspheres on a predetermined portion of the print media.

4. The thermal printer of claim 3, wherein the thermal printer is programmed to only heat the portion of the print media including the microspheres.

5. The thermal printer of claim 1, wherein the desired design is text or a pattern.

6. A method of embossing a security feature onto print media, comprising:
receiving print media having a plurality of microspheres, wherein each of the plurality of microspheres is configured to independently expand when heated;
receiving a desired design to be embossed on the print media;
selectively heating a portion of the print media in the shape of the desired design, such that the heated microspheres expand and emboss the print media with the desired design.

7. The method of claim 6, wherein the step of selectively heating a portion of the print media comprises the steps of:
selectively heating a first portion of the print media to a first temperature;
selectively heating a second portion of the print media to a second temperature, wherein the first temperature is higher than the second temperature, such that the resulting embossing of the first portion is higher than the embossing of the second portion.

8. The method of claim 6, wherein the print media only includes the microspheres on a predetermined portion of the print media.

9. The method of claim 7, wherein the step of selectively heating a portion of the print media only heats the portion of the print media including the microspheres.

10. The method of claim 6, wherein the desired design is text or a pattern.
